(19) United States
(12) Patent Application Publication
(10) Pub. No.: US 2007/0091244 A1
(43) Pub. Date: Apr. 26, 2007

(54) Liquid crystal display device

(75) Inventors: Jia-Yi Wu, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/250,302

(22) Filed: Oct. 14, 2005

(51) Int. Cl. G02F 1/1339

(52) U.S. Cl. 349/153

(57) ABSTRACT

A liquid crystal display panel (20) includes a first substrate (200) with a black matrix (240) disposed on an inner surface therefore, a second substrate (220), and an opaque sealant (280) disposed around the black matrix and combined the first and second substrates together. The opaque sealant and the edge of the black matrix cooperatively prevent from light leakage in a peripheral region of a pixel region of the liquid crystal display panel. According to this configuration, the liquid crystal display panel ensures that the sealant can be completely cured during the manufacturing process, and the efficient utilization of the substrate is higher.

### FIELD OF THE INVENTION

The present invention relates to a liquid crystal display (LCD) device, and more particularly to an LCD panel with an improved sealant structure, in which the LCD panel is manufactured by a one drop fill process.

### BACKGROUND

An LCD device has the advantages of portability, low power consumption, and low radiation, and has been widely used in various portable information products such as notebooks, personal digital assistants (PDAs), video cameras and the like. Furthermore, the LCD device is considered by many to have the potential to completely replace CRT (cathode ray tube) monitors and televisions.

Normally, an LCD panel includes a color filter (CF) substrate, a thin film transistor (TFT) substrate, and a liquid crystal layer positioned between the CF substrate and the TFT substrate. The TFT substrate further includes a plurality of pixel array regions arranged in arrays on the surface, and each pixel array region includes a TFT and a pixel electrode for controlling orientation angles of liquid crystal molecules such that each pixel can generate different colors and gray scales.

In general, LCD panels can be divided into two types according to methods of filling liquid crystal molecules: vacuum injection LCD and one drop fill (ODF) LCD. In a vacuum injection LCD, the CF substrate and the TFT substrate are combined together with a sealant, and only a hole is kept. Then, liquid crystal molecules are slowly injected into the space between the CF substrate and the TFT substrate by capillarity action. However, this requires a lot of time (ex: several days for assembling a large size LCD) and a great amount of liquid crystal molecules. Therefore, the vacuum injection LCD method is usually only applied to fill small panels with liquid crystal molecules. In an ODF LCD, first, a sealant layer is pasted onto a bordering part of the TFT substrate. Then, liquid crystal molecules are dropped on the central part of a pixel region, and the CF substrate and the TFT substrate are affixed. Finally, an ultraviolet light is utilized to irradiate the sealant for hardening the sealant such that the CF substrate and the TFT substrate are tightly combined together. In comparison with vacuum injection method, ODF method is more effective (it takes only a few hours to fill a large size LCD), and needs fewer liquid crystal molecules. Hence, at present, the ODF method is normally applied to fill large LCD panels with liquid crystal molecules.

Please referring to FIG. 2, a schematic, cross-sectional view of a peripheral part of related ODF LCD panel is shown. The ODF LCD panel 10 includes a CF substrate 100 with a black matrix 140, a TFT substrate 120 with a conducting layer 160, a liquid crystal layer (not labeled) positioned between the substrates 100 and 120, and a sealant 180 disposed at a peripheral region between the black matrix 140 and the conducting layer 160 of the substrates 100 and 120.

Since the sealant is photocuring material, in the process of manufacturing the ODF LCD panel 10, it is necessary to apply ultraviolet light to harden the sealant 180 while superposing the substrates 100 and 120. However, in the process, the ODF LCD 10 has a problem that the liquid crystal is contaminated by an uncured sealant 180 resulted from ultraviolet light being blocked by a black matrix 140, a conducting layer 160, etc from irradiating the sealant. The liquid crystal molecules are liable to be polluted by the uncured sealant 180 so that the display quality of the ODF LCD panel 10 will be deterioratd.

Another ODF LCD panel includes a black matrix, and a sealant disposed separate from the black matrix which overcomes the above-described problem. In the process of manufacturing this ODF LCD panel, it pre-arranges a sealant region at peripheral portion of one of a substrate of the ODF LCD panel so that the black matrix and the sealant are completely unsuperposed. Then, the sealant may be completely cured by UV light without the blocking of the black matrix.

However, the design of pre-arranging a sealant region at a peripheral portion of substrate separate from the black matrix will increase the width of margin of the substrate, and then the efficient utilization of the substrate is decrease. As a result, the cost of manufacturing the ODF LCD panel is also increased.

What is needed, therefore, is an ODF LCD panel, in which the sealant can be completely cured, and the efficient utilization of the substrate is higher.

### SUMMARY

In an embodiment, a liquid crystal display panel includes a first substrate with a black matrix disposed on an inner surface therefore, a second substrate, and an opaque sealant disposed around the black matrix and combined the first and second substrates. The opaque sealant and the edge of the black matrix cooperatively prevent from light leakage in a peripheral region of pixel region of the liquid crystal display panel.

According to this configuration, the sealant is disposed around the black matrix, and the black matrix and the sealant are completely unsuperposed. Then, the sealant may be completely cured by UV light without the blocking of the black matrix. Moremore, part of the edge of the black matrix is replaced with opaque sealant, which can economize the margin area of the substrate of the liquid crystal display panel. The opaque sealant and the edge of the black matrix cooperatively prevent from light leakage in a peripheral region of pixel region of the liquid crystal display panel. It ensures that the sealant can be completely cured during the manufacturing process, and the efficient utilization of the substrate is higher.

Other advantages and novel features will become more apparent from the following detailed description when taken in conjunction with the accompanying drawings.

### BRIEF DESCRIPTION OF THE DRAWINGS

FIG. 1 is a schematic, cross-sectional view of a peripheral part of an ODF LCD panel according to a preferred embodiment of the present invention.

FIG. 2is a schematic, cross-sectional view of a peripheral part of a related ODF LCD panel.

### DETAILED DESCRIPTION OF PREFERRED EMBODIMENTS

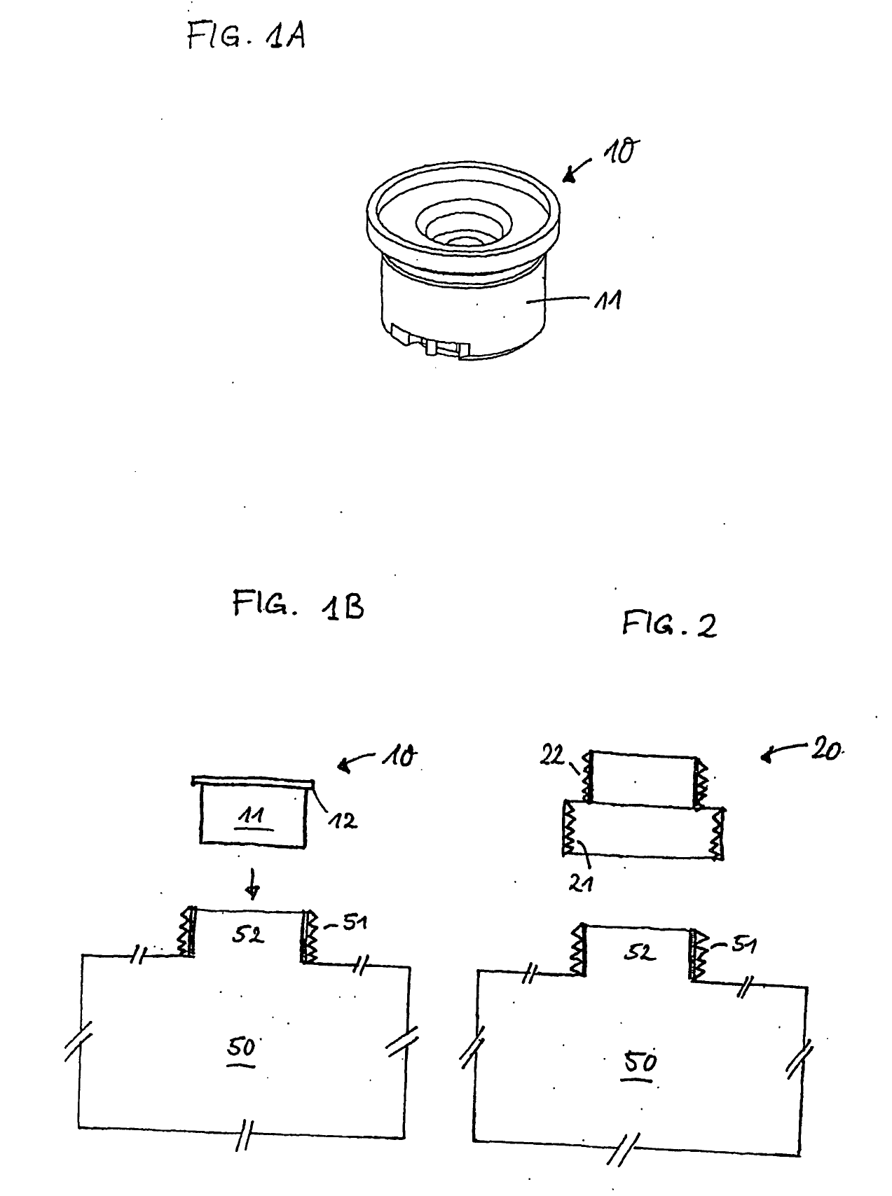

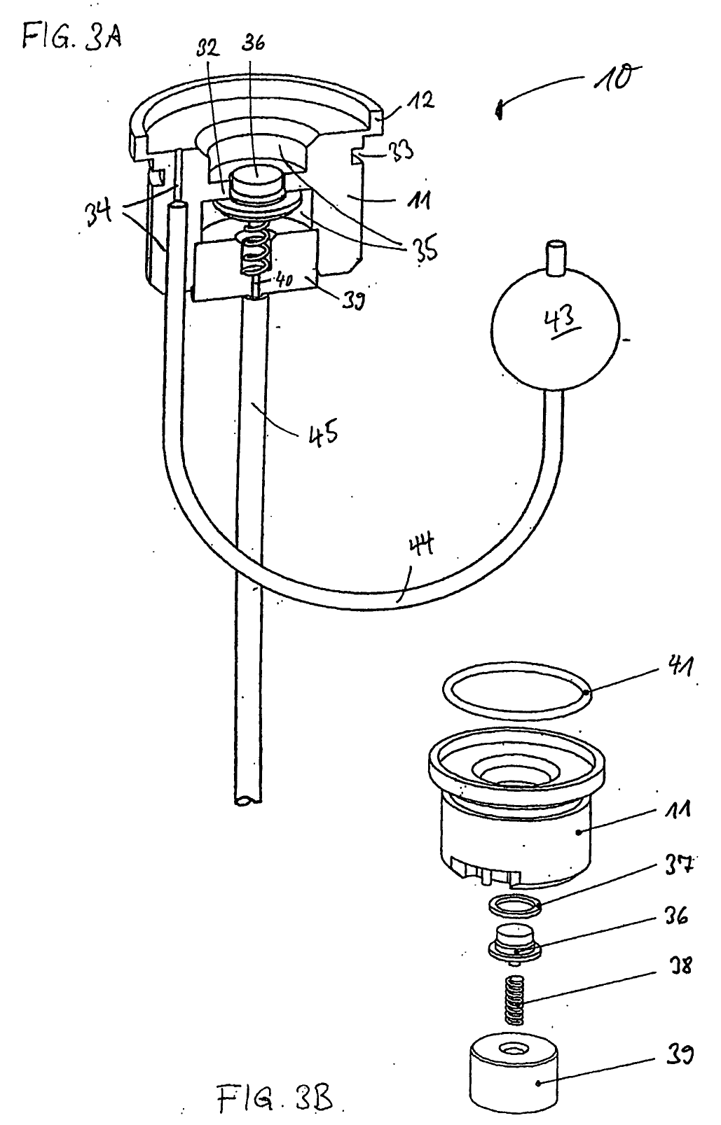

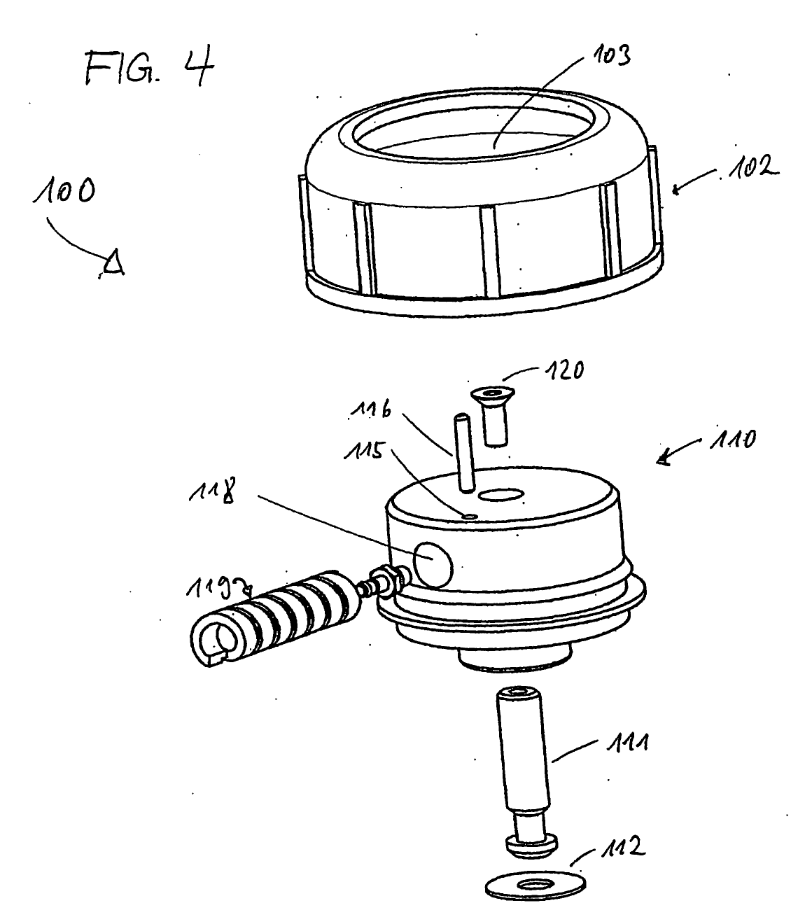

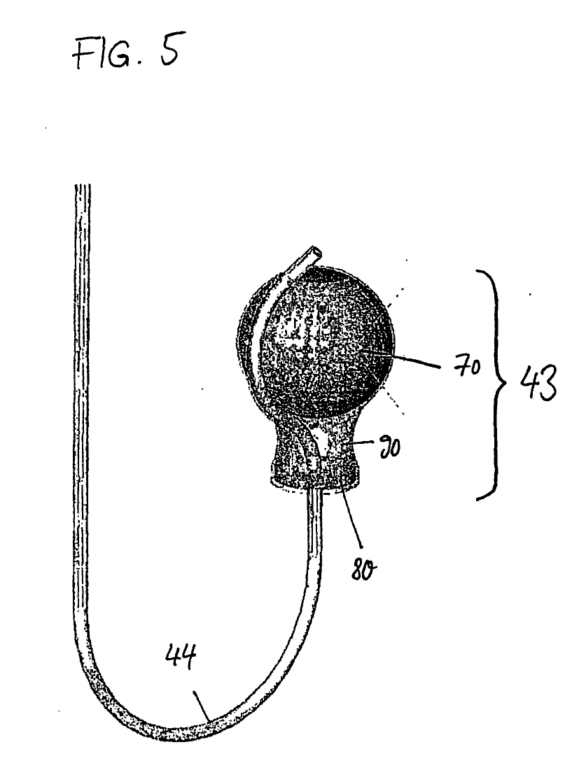

Referring to FIG. 1, a schematic, cross-sectional view of a peripheral part of an ODF LCD panel according to a preferred embodiment of the present invention is shown. The ODF LCD panel 20 includes a first substrate 200, a second substrate 220, a liquid crystal layer 230, and a sealant 280. The two substrates 200 and 220 are disposed opposite to each other. The sealant 280 is disposed at a peripheral region between the two substrates 200 and 220, and tightly affixed them together. The sealant 280 seals a space between the substrates 200 and 220 for containing the liquid crystal molecules to form the liquid crystal layer 230.

The first substrate 200 has a black matrix 240 disposed on an inner surface thereof opposite to the second substrate 220. The black matrix 240 is arranged corresponding to a pixel region (not labeled) of the liquid crystal display panel 20. The process of manufacturing the black matrix 240 includes the steps of: etching an array like black matrix 240 on the inner surface of the substrate 200 to define a regular array of holes (not labeled) therein; then repeating filling three primary color resists of R (red), G (green), and B (blue) in the holes to form a color layer (not shown); finally, taking off part of the edge of the black matrix 240 to minimize the width of the peripheral region thereof and to leave a sealant region for pasting sealant 280.

The sealant 280 is disposed around the black matrix 240. The sealant is a kind of photocuring sealant, which is made of resin material and doped carbon black so as to make the sealant opaquely. It is easy to control the doped ratio of the carbon black to make the opaque sealant has an optical density equal to or larger than 2.5, which approaches to the optical density of the common black matrix made of chromium (Cr) or the like. The sealant 280 replaced part of the edge of the black matrix 240, and cooperative with the edge of the black matrix preventing from light leakage in a peripheral region of pixel region of the liquid crystal display panel 20. Moreover, the sealant 280 includes spacers 281 therein for maintaining a uniform distance between the peripheral regions of the substrates 200 and 220, which ensures that the LCD panel 20 has a consistent cell gap. The spacer 281 is a kind of rod spacer.

Since the sealant 280 is disposed around the black matrix 240, and the black matrix 240 and the sealant 280 are completely unsuperposed. Then, the sealant 280 may be completely cured by UV light without the blocking of the black matrix 240. Moremore, part of the edge of the black matrix 240 is replaced with opaque sealant 280, which can economize the margin area of the substrates 200 and 220 of the liquid crystal display panel 20. It ensures that the sealant 280 can be completely cured during the manufacturing process, and the efficient utilization of the substrates 200 and 220 is higher.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display panel, comprising:
a first substrate whit a black matrix disposed on an inner surface therefore corresponding to a pixel region of the liquid crystal display panel;
a second substrate;
an opaque sealant disposed around the black matrix and combined the first and second substrates.

2. The liquid crystal display panel as claimed in claim 1, wherein the sealant is photocuring sealant.

3. The liquid crystal display panel as claimed in claim 2, wherein the sealant has an optical density as 2.5.

4. The liquid crystal display panel as claimed in claim 2, wherein the sealant has an optical density larger than 2.5.

5. The liquid crystal display panel as claimed in claim 4, wherein the sealant is made of resin material and carbon black.

6. The liquid crystal display panel as claimed in claim 5, wherein the sealant further comprises spacers therein.

7. The liquid crystal display panel as claimed in claim 6, wherein the spacers are rod spacers.

8. The liquid crystal display panel as claimed in claim 1, wherein the liquid crystal display panel is a one drop fill LCD panel.

9. A liquid crystal display panel, comprising:
a first substrate whit a black matrix disposed on an inner surface therefore;
a second substrate;
an opaque sealant disposed around the black matrix and combined the first and second substrates, the opaque sealant and edge of the black matrix cooperatively preventing from light leakage in a peripheral region of pixel region of the liquid crystal display panel.

10. The liquid crystal display panel as claimed in claim 9, wherein the sealant is photocuring sealant.

11. The liquid crystal display panel as claimed in claim 10, wherein the sealant has an optical density as 2.5.

12. The liquid crystal display panel as claimed in claim 10, wherein the sealant has an optical density larger than 2.5.

13. The liquid crystal display panel as claimed in claim 12, wherein the sealant is made of resin material and carbon black.

14. The liquid crystal display panel as claimed in claim 13, wherein the sealant further comprises rod spacers therein.

15. A liquid crystal display panel, comprising:
a first substrate whit a black matrix disposed on an inner surface therefore corresponding to a pixel region of the liquid crystal display panel;
a second substrate with a conducting layer on an inner surface;
an opaque sealant circumferentially disposed around at least one of the black matrix and the conducting layer to combine the first and second substrates together.

16. The liquid crystal panel as claimed in claim 15, wherein said one of the black matrix and the conducting layer is the black matrix.

17. The liquid crystal panel as claimed in claim 15, wherein the sealant is positioned upon the other of said black matrix and the conducting layer in a vertical direction.
